(19) United States
(12) Patent Application Publication
(10) Pub. No.: US 2003/0076809 A1
(43) Pub. Date: Apr. 24, 2003

(54) Methods for detecting and polling downstream modems

(75) Inventors: Robert P. Basil, Lawrenceville, GA (US); Stephane Dennis Jacques Chapeau, Duluth, GA (US); Bradley Richard Ree, Snellville, GA (US); John B. Terry, Cumming, GA (US); Dorothy Terry, Cumming, GA (US)

Correspondence Address: DANIELS & DANIELS, P.A., SUITE 200, GENERATION PLAZA, 1822 N.C. HIGHWAY 54, EAST, DURHAM, NC, 27713, US

(73) Assignee: coaXmedia, Inc., Cumming, GA

(21) Appl. No.: 10/205,523

(22) Filed: Jul. 25, 2002

Related U.S. Application Data
(60) Provisional application No. 60/309,809, filed on Aug. 3, 2001.

(51) Int. Cl. H04J 3/16; H04B 7/212

(52) U.S. Cl. 370/346; 370/347

(57) ABSTRACT

A method of finding the address of a previously undiscovered client modem first detects the presence of a previously undiscovered client modem on a tree and branch network then uses an efficient method to discern the address for the newly discovered client modem. The method can be coupled with a group polling method for efficiently polling client modems that minimizes the time wasted by polling a modem without data to transmit. In group polling, a broadcast message is sent to all modems (or a selected subset of modems). Each modem requiring service responds with a short burst of energy in its predefined time slot. These time slot responses are recorded and then normal poll messages are sent out to only the modems requesting service. The disclosure contains variations of these methods. This abstract is provided for patent searches, and not as a limitation on the scope of the claims.

This application claims priority from co-pending U.S. Provisional Application No. 60/309,809 for Methods for Efficiently Detecting and Polling Downstream Modems in a Shared Transmission Media Such as Passive Coax Distribution on a Tree and Branch Network.

### FIELD OF THE INVENTION

This invention relates to the field of communication systems and methods, in particular, to packet communications between a central server and a number of distal modems over a shared transmission media such as passive coax distribution on a tree and branch network.

### BACKGROUND

This application builds upon concepts disclosed in co-pending application with common assignee with from U.S. patent application Ser. No. 09/482,836 for High Speed Data Communications over Local Coaxial Cable with the priority date of Jan. 13, 1999. To reduce repetition with the material disclosed in the '836 application, the '836 application is incorporated by reference.

This application also extends on concepts disclosed in co-pending application with common assignee with U.S. patent application Ser. No. 09/818,378 for Architecture and Method for Automatic Distributed Gain Control for Modem Communications over Passive Multipoint Networks with the priority date of Mar. 30, 2000. To reduce repetition with the material disclosed in the '378 application, the '378 application is incorporated by reference.

The present application represents an improvement over the previously filed applications so to the extent that there is a conflict between the text or figures incorporated by reference and the text or figures of this disclosure, the contents of this disclosure would, of course, prevail.

For the convenience of the reader, various acronyms and other terms used in the field of this invention are defined at the end of the specification in a glossary. Other terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

In order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

The '836 application discloses an RF coax transmission system in which all information flows in a continuous manner from the server to one or more client modems (downstream) and is sent in bursts from the one or more client modems to the server (upstream).

Data from the server to the one or more client modems is continuous and an AGC circuit on the client allows the client to adjust it's receive power level and start decoding the downstream RF data. Data flowing from the client(s) to the server is burst, so the RF power levels for transmissions sent by the client(s) are adjusted in an iterative manner to compensate for the loss back to the server. This concept is described in the '378 application.

Data flow downstream and upstream is concurrent, as the upstream channel and the downstream channel each operate on unique frequencies to transmit their data.

Data that flows downstream is recognized at each client modem by the unique address that is added to the downstream message header. The client modem, hence its address, is found by the server by a process called discovery.

Prior art processes for discovery and polling place burdens on networks by adding to the overhead necessary to run the system. Overhead comes in two basic types, first, the portion of the data frame devoted to administration rather than delivery of payload; and second, the use of frames sent for administrative purposes without true payloads. (“True payloads” is meant to distinguish the dummy payloads or the delivery of control settings in contrast to delivery of data payloads). The latter form of overhead is truly burdensome as these administrative frames use the communication channels (downstream and upstream) without delivering true payloads.

It is an objective of the present invention to provide an efficient process for the server to identify the addresses of one or more undiscovered client modems.

It is a further objective of the present invention to improve the polling process to reduce the time spent polling known client modems that do not have a payload to transmit upstream.

These and other advantages of the present invention are apparent from the drawings and the detailed description that follows.

### BRIEF SUMMARY

The disclosure includes various versions of a method to efficiently discover the address of a client device such as a client modem by determining that there is an undiscovered device that is responding and then iteratively determining the value of each of the unknown bits in the address of the newly discovered client device. Once the address of the undiscovered device is fully discerned, then the newly discovered device can be instructed to not respond to downstream communications that would require responses from undiscovered devices with data to transmit. The disclosed method works to identify the address of an undiscovered client modem even if two or more undiscovered modems are responding.

The disclosure also includes various versions of a method to efficiently poll a group of client modems to determine which ones (if any) have upstream data to transmit. The use of a group polling message and the response of the many client modems into a concatenated series of brief time slots allows for the quick and efficient identification of the small subset of client modems with upstream data to transmit. Once the subset of client modems is identified, specific polling requests sent to the individual client modems in the subset can be sent to complete the current round of polling. By reducing the inefficiency in the polling process, modems can be polled more frequently.

In a preferred embodiment, the group polling can be used as an initial step in the identification of undiscovered client modems as the undiscovered client modems can be programmed to respond to group polling requests by responding within a time slot set aside for undiscovered client modems. Since the group polling uses a level detector to determine the presence or absence of a response, the method works even if two or more undiscovered modems respond during the same time slot.

### BRIEF DESCRIPTION OF THE DRAWING

FIG. 1 contains an illustration of the magnitude of the difference between 1) polling individual devices and wasting the upstream channel when there is not any upstream data at a specific polled device and 2) the response from many modems to a group polling message. The polling of three individual modems is contrasted with the group polling of one hundred active modems.

### DESCRIPTION OF THE PREFERRED EMBODIMENTS

The present invention will now be described more fully hereinafter with reference to the accompanying drawings, in which preferred embodiments of the invention are shown.

This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Discovery

After certain events such as when a client modem powers up, is reset, or is reconnected, it needs to be discovered by the server so that it can be polled to check to see if the client modem has upstream data and thus needs to use the upstream channel.

The method of finding the address of undiscovered client modem has two parts. The first part is to detect the presence of a previously undiscovered client modem. The second part is to efficiently discern the address for the client modem.

The method starts by sending the lowest address available in a special message (a discovery message) and waiting for a response from any undiscovered client modem(s) that have addresses greater than or equal to the address sent in the discovery message. If there are any undiscovered modems listening on the system, they will respond. This is because the discovery message forces all undiscovered modems to respond since any address of an undiscovered modem must be equal or greater than the lowest possible address sent in the discovery message. Previously discovered modems will have already received a message indicating that the modem has been discovered and the modem should no longer respond to discovery messages. Thus, only undiscovered modems reply.

Since the upstream path attenuation is initially unknown, the client must respond with an upstream message sent at full power to guarantee that the message will be strong enough to trigger the server's receiver. A level indicator is used on the server to show that a client has responded. The system does not rely on the specifics of the data sent with the response from the newly discovered client modem. Note that even if two modems have been added since the last discovery message, the response from two modems to the discovery message is not a problem as the server card is looking for any type of response from the set of modems. Thus, distortion from bus contention is not a problem.

In a preferred embodiment, once the server has found that an undiscovered client is listening and requires upstream service, it will repeat the discovery message with the MSB of it's the address field set. For example, for a 4 bit address field, the address is changed from the lowest possible address to 1000 (decimal 8). This means that the address is now set to a value approximately half of the maximum address value (for example 8 out of a 0-15 range of addresses). Any undiscovered modem with an address greater than or equal to the mid value address will respond and that responding clients address will be known to have the MSB set. If a modem does not respond then it is known that any undiscovered modem(s) does not have an address with the MSB set.

The discovered/resolved state of the MSB is saved and used in the next iteration of the discovery process as the next most significant bit is tested. This process is repeated for each address bit until all address bits have been resolved. The total number of iterations is dependant on the number of address bits needed to discover.

The fact that the modems respond to the discovery request if their address is greater than or equal to the requested address is not significant to this patent. The same discovery process could be done if the modems were all commanded to respond if their addresses were less than or equal to or less than or greater than the requested discovery address. The choice of test criteria will alter which of multiple undiscovered modems is identified first but does not deviate from the general nature of the present invention. Preferred embodiments discern one bit of the undiscovered address per iteration. Other less efficient methods of discerning the undiscovered address may also be employed.

An example showing the address resolution process with a 4 bit address:

1. Server sends out a discovery request with the address set to 0.

2. At least one client responds. (continue the process because there is at least one client undiscovered, else the discovery process is complete)

3. Server sends out a discovery request with the address set to 8.

4. No client responds. (MSB of the client address is zero)

5. Server sends out a discovery request with the address set to 4.

6. At least one client responds. (bit 2 of address is set)

7. Server sends out a discovery request with the address set to 6.

8. At least one client responds. (bit 1 of address is set)

9. Server sends out a discovery request with the address set to 7.

10. No client responds. (bit 0 of address is zero)

11. Server knows that a client exists with the address 6.

A second example with two undiscovered modems with addresses 6 and 5:

1. Server sends out a discovery request with the address set to 0.

2. At least one client responds. (continue the process because there is at least one client undiscovered, else the discovery process is complete)

3. Server sends out a discovery request with the address set to 8.

4. No client responds. (MSB of address is zero)

5. Server sends out a discovery request with the address set to 4.

6. At least one client responds. (bit 2 of address is set)

7. Server sends out a discovery request with the address set to 6.

8. At least one client responds. (bit 1 of address is set)

9. Server sends out a discovery request with the address set to 7.

10. No client responds. (bit 0 of address is zero)

11. Server knows that a client exists with the address 6.

A careful observer will note that the process of discovering one client modem with an address of 6 is the same as the process discovering the first client modem out of two undiscovered client modems with addresses 6 and 5. Thus, the existence of another client modem with a similar address does not create any problems since a level indicator is used on the server to detect that a client modem has responded.

Now that the client modem address of 6 is discovered, the discovered client modem is instructed not to respond to discovery requests. The process continues and steps through the same steps to locate the remaining undiscovered client modem.

It is important to note that the savings from using the process described above grows with the number of potential addresses. Applicant currently tests for the presence of an address based on 24 bits rather than 4.

Note that an alternative embodiment could use another type of message to obtain responses from any previously undiscovered devices. The preferred embodiment uses an extreme address so that all devices will be either less than or equal to the extreme address in systems that respond when the unknown address is lower or equal, or so that all devices are equal or greater than a minimum address in systems that respond when the unknown address is greater or equal to the address in the downstream message. An initial message without an address would work as the first step if undiscovered devices are programmed to respond to that message.

Note that the process of discovery can be implemented in connection with group polling as described below, but the process to discover undiscovered devices can be run periodically, or based on some other trigger rather than or in addition to a specific response to a group polling.

A better understanding of how the discovery process fits into the overall scheme is explained as part of the explanation of the group polling process (described below).

Group Polling

The discovery message can be sent out by the server at any time, however, a special mechanism exists that allows the client modem itself to request a discovery to take place. This special mechanism is a part of group polling.

To identify clients with upstream data ready for transmission, a special broadcast message is sent to all client modems. The clients with upstream data ready respond in pre-assigned unique time slots that distinguish one modem from another modem.

In a most preferred embodiment, time slots are assigned based on their order in our polling table, leaving time slot 0 for undiscovered modems. The network software driver will assign a place in the polling table to discovered addresses. The actual place in the table is irrelevant, but gaps are generally filled with newly discovered modems. Thus, the gaps are ultimately removed without the need to reassign index values to the remaining set of active modes. In one preferred embodiment, each index allows for a 5 μs time slot for a client modem to transmit a response.

Note that the choice of a 5 μs time slot duration as opposed to another duration is actually dependent on the distance from the server to the furthest client as the time slot window is set based on round trip maximums for the packet to traverse the coax from the server to the client and back again. One preferred embodiment allows uses a default value of 5 μs (nominal), but can be increased in 5 μs steps up to 20 μs.

If the 5 μs time slot is adequate and the system has a total of 128 available timeslots, the system needs 128*5 μs=640 μs for a response to a group poll to all 128 modems. Optionally, a system could reduce the time allotted for group polling response to a smaller time period by limiting the allocated time to that sufficient for a response from all active client modems. As noted above, the preferred embodiment allocates time slots to active modems as they are added to the system and fills in any gaps thus making it possible to allocate all of the active modems to a contiguous set of polling response times (ignoring the transient effect of an unfilled gap from a recent move from active to inactive of a client modem). For a system with a large maximum number of possible active sessions and a relatively smaller number of active sections, the savings from the reduction in allocated polling response time could be appreciable.

### EXAMPLES

A pair of simple examples will illustrate the differences in operation in normal polling and group polling when used with a 100 modem system.

Normal Polling Example

Polling: A control message sent from a master terminal to a slave terminal as an invitation for the slave to transmit. From: http://www.flw.com/define_p.htm

polling Telecommunications. 1. a process that interrogates each terminal on a shared communications line to determine which terminal or terminals have messages waiting to be transmitted over a common bus. a process that interrogates each terminal on a shared communications line to determine which terminal or terminals have messages waiting to be transmitted over a common bus. 2. a process by which a processor allows an external unit or units to feed it with information selectively in turn. a process by which a processor allows an external unit or units to feed it with information selectively in turn. FROM: http://www.harcourt.com/dictionar/def/7/9/4/5/7945300.html

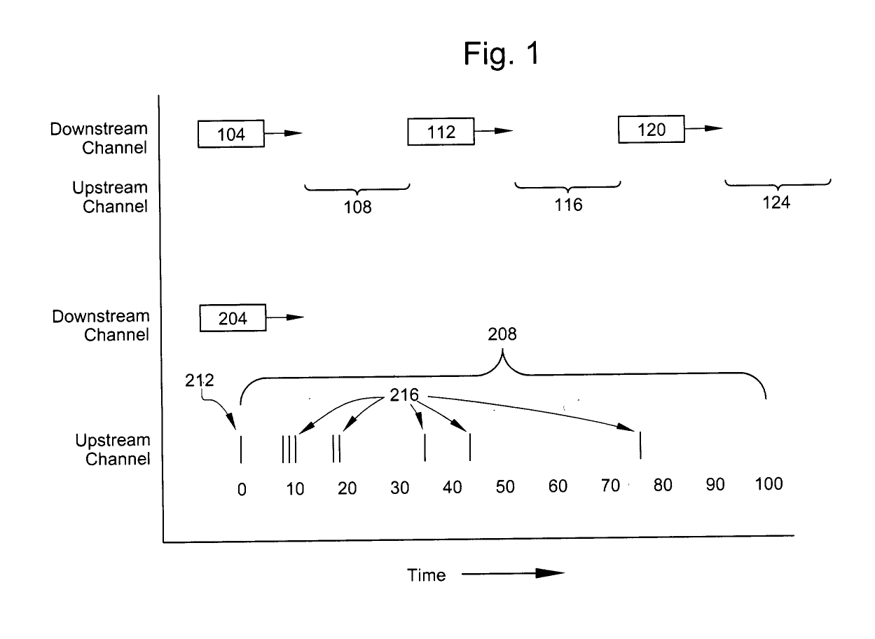

Turning to FIG. 1, in polling of the type known in the prior art, each modem is successively polled for upstream data. When polled, the polled modem sends back a short response with data if it has upstream data ready. In this way every modem is sequentially polled for upstream data. Because clients only look for the start of a message on frame boundaries, an entire frame time slot is wasted if no upstream traffic is ready for transport. As shown in the top two lines of FIG. 1, the polling of unit 1, 2, and 3 with targeted polling requests 104, 112, and 120 does not result in any response frames from the three polled modems but the upstream channel was allocated for time slots 108, 116, and 124. These time slots were sized for the transmission of a response frame. The allocation of time slots for response frames lead to many unused time slots and this results in decreased utilization of the upstream channel. Every poll to a client modem without data is wasted. The process is highly repetitive.

Modem1 is polled, responding with data if it has data ready.

Modem2 is polled, responding with data if it has data ready.

Modem3 is polled, responding with data if it has data ready.

Modem4 is polled, responding with data if it has data ready.

Modem5 is polled, responding with data if it has data ready.

Modem1 is polled, responding with data if it has data ready.
Modem2 is polled, responding with data if it has data ready.
Modem3 is polled, responding with data if it has data ready.
Modem4 is polled, responding with data if it has data ready.
Modem5 is polled, responding with data if it has data ready.
. . .
. . .
. . .
Modem97 is polled, responding with data if it has data ready.
Modem98 is polled, responding with data if it has data ready.
Modem99 is polled, responding with data if it has data ready.
Modem100 is polled, responding with data if it has data ready.
Modem1 is polled, responding with data if it has data ready.
Modem2 is polled, responding with data if it has data ready.
. . .
. . .
. . .

Group Polling Example

To minimize the time wasted by polling a modem without data to send, a group polling method is utilized. In group polling, a broadcast message 204 is sent to all modems. Each modem requiring service responds with a short burst of energy in its predefined time slot within an aggregate response time 208. These time slot responses 216 are recorded and then normal poll messages are sent out to only the few client modems requesting service. For example, in FIG. 1, the response to the broadcast 204 to one hundred active client modems includes the information that client modems 8, 9, 10, 18, 19, 34, 43, and 76 have data. The time slots are fractions of a normal response frame. In the current system, a normal frame is 62 μs and a time slot is 5 μs.

Therefore in this particular interface there is a an opportunity for at least a 12:1 increase in performance by decreasing the wasted time polling by allowing all modems to tell the system the identity of the modems that needs service in a fraction of the time it takes to go though the list of available modems. Once the list of modems requiring service is complete, normal polls to those specific modems are carried out. By having this two step process, the cost in upstream channel time is held very low for the large percentage of modems without data to send. Another benefit of the system is that the downstream modems can be polled more frequently since less time is wasted with full polling of modems without data to transmit. This increase in modem polling will decrease the delay associated with data awaiting permission for the modem to use the upstream channel. The benefits of this system are increased if the vast majority of modems do not have data to send.

Another version of this invention is to allocate certain client modems to a group that responds to a certain group polling broadcast message and allocate other client modems to respond to a different group polling broadcast message. Each group of client modems would respond to the appropriate group polling broadcast message and with individual client modems responding within the allocated time slots. The advantages described for unified group polling would apply to split group polling. The reasons for employing split group polling may include having so many client modems that is desirable to have a two or more smaller concatenated periods of group polling responses. The sub-groups could be selected based on the distance of the client modems from the server. The sub-groups could also be set up in order to provide differing levels of service, that is one sub-group could be polled more frequently than another sub-group.

Although the preferred embodiment sends a positive signal in the time slot to indicate having data to send, one of skill in the art will recognize that a system that causes client modems to send a response in the allocated slot when the client modem does not have data to send upstream would be within the scope of the disclosed invention. Likewise other signals discernible with conventional equipment could be established by those of skill in the art. For example, if the time slot allocated for response was sufficiently long, a response in the beginning of the time slot may be distinguished from a response in the latter portion of the time slot. Here is a sample of the two-step polling process.

Group poll sent with modems 2 and 65 responding
[that they have upstream data to send].
Poll to modem2, who responds with data.
Poll to modem65, who responds with data.
Group poll sent with no modems responding.
Group poll sent with no modems responding.
Group poll sent with no modems responding.
Group poll sent with modems 2, and 32 responding.
Poll to modem2, who responds with data.
Poll to modem32, who responds with data.
Group poll sent with modems 2, 22, 74, and 99 responding.
Poll to modem2, who responds with data.
Poll to modem22, who responds with data.
Poll to modem74, who responds with data.
Poll to modem99, who responds with data.
Group poll sent with no modems responding.
Group poll sent with modem 65 responding.
Poll to modem65, who responds with data.
. . .
. . .
. . .

Combined Example of Group Polling and Discovery

The following example shows the one preferred embodiment of the entire process with an undiscovered modem and upstream data ready. In order to provide context, the process is illustrated alongside of preferred implementations of other innovative methods disclosed in the referenced co-pending applications.

1. Server sends out group poll with address field set to 0000.

2. Undiscovered client X initiates an upstream request by transmitting in time slot 0 (212 in FIG. 1) in response to the group poll. (The server recognizes the presence of an undiscovered client as time slot 0 is set aside for undiscovered modems.) The server can be programmed to immediately begin the process to discover the address of the one or more undiscovered modems, or the server can initiate the discovery process later such as after polling the previously identified modems that responded with an indication that each has upstream data to transmit.

3. The server starts a discovery sequence which begins with the address resolution of the undiscovered client X. The server sends out a group poll with the address 1000.

4. Once the address resolution is complete, a sequence of poll messages are sent to the client X to ensure its upstream transmit level is set optimally in accordance with the '378 application referenced above.

5. After client X's transmit level is set, a normal poll message is sent to confirm the resolved address. In one preferred embodiment, the power level is set by sending a series of polls where the response is basically ignored until the power level is correct. At this point 3 more polls are sent where the responses are not ignored. If any of these 3 final polls are received correctly, then the modem is ready to be sent a message indicating that the modem is now discovered, and registered with the server and giving the client an index value to indicate what time slot to use for group polling responses.

6. After the address is confirmed properly by client modem X with a valid upstream response, a final message is sent to client modem X telling it that it is registered. Client modem X is provided an index to get upstream service. The index is used to specify the time slot to respond in. Client modem X is commanded not to respond to anymore discovery messages. (If the address is not confirmed, then the discovery is aborted and both server and client X return to their previous states.)

7. A group poll is sent and all modems with upstream data respond, including client modem X which responds in its time slot in accordance with the new assigned index if client modem X has data to send upstream.

8. Like other previously identified modems that responded to indicate having upstream data to send, client modem X is issued a normal poll addressed specifically to Client modem X to retrieve the data.

The preferred embodiment uses a positive signal from any undiscovered modems in the allocated time slot and also uses a positive signal from any previously discovered modems with data to send upstream. As discussed above, the indication that a discovered modem has data to send could be the absence of a signal or a modified signal but this would not be readily implemented for the undiscovered modems and there is no apparent advantage to using two different schemes.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

For example, although this invention has been discussed in the context of a tree and branch network using legacy coax cable, the invention could be employed over other shared communication media with a hub or server and many client devices.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

Glossary of Abbreviations

| | |
|---|---|
| AGC | Automatic Gain Control |
| DVB | Digital Video Broadcast |
| LSB | Least Significant Bit |
| MSB | Most Significant Bit |
| RF | Radio Frequency |
| TDM | Time Division Multiplex |

We claim:

1. A method for discovering an address of a currently undiscovered device with an N-bit address on a shared media with a downstream channel and an upstream channel, the method comprising:
A. Sending a first type message on the downstream channel;
B. Interpreting a response occurring on the upstream channel as confirmation of the existence of at least one undiscovered device;
C. Discerning the address of at least one of the responding undiscovered devices by:
i. Sending a second type message on the downstream channel, the second type message containing an address field with a most significant bit set to 1 and the rest of the bits set to 0;
ii. If a response comes back on the upstream channel, then the most significant bit is set to 1, else the most significant bit is set to 0;
iii. Setting MSB Index=2;
iv. FOR MSB Index less than N;
a. Sending a subsequent second type message with the previously discerned value(s) for the one or more most significant bits with the next most significant bit set to 1 and any remaining bits set to 0;
b. If a response comes back on the upstream channel, then the next most significant bit is set to 1, else the next most significant bit is set to 0; and
v. Increment MSB Index=MSB Index+1; and
D. Sending an instruction to the newly discovered device through use of the discerned address to instruct the discovered device to not respond to subsequent first type messages.

2. The method of claim 1 wherein the step of interpreting a response occurring on the upstream channel as confirmation of the existence of at least one undiscovered device comprises using a level indicator to detect a response such that the ability to detect a response is not impacted by bus contention from multiple responses.

3. The method of claim 1 wherein the first type message and the second type message are the same type, and the first type message uses a minimum address so that any undiscovered device will respond to the first type message.

4. A method for discovering an address of a currently undiscovered device with an N-bit address on a shared media with a downstream channel and an upstream channel, the method comprising:
A. Sending a first type message on the downstream channel;
B. Interpreting a response occurring on the upstream channel as confirmation of the existence of at least one undiscovered device;
C. Discerning the address of at least one of the responding undiscovered devices by:
i. Sending a second type message on the downstream channel, the second type message containing an address field with a first bit set to a first binary value and the rest of the bits set to a second binary value;
ii. If a response comes back on the upstream channel, then the first bit is set to a third binary value, else the first bit is set to a fourth binary value;
iii. Setting bit Index=2;
iv. FOR bit Index less than N;
a. Sending a subsequent second type message with the previously discerned value(s) for the address, the next unknown bit set to a fifth binary value and any remaining bits set to a sixth binary value;
b. If a response comes back on the upstream channel, then the next unknown bit is set to a seventh binary value, else the next unknown bit is set to an eighth binary value; and
c. Increment bit Index=bit Index+1; and
D. Sending an instruction to the newly discovered device through use of the discerned address to instruct the discovered device to not respond to subsequent first type messages.

5. The method of claim 4 wherein the step of interpreting a response occurring on the upstream channel as confirmation of the existence of at least one undiscovered device comprises using a level indicator to detect a response such that the ability to detect a response is not impacted by bus contention from multiple responses.

6. The method of claim 4 wherein the first type message and the second type message are the same type, and the first type message uses an extreme address so that any undiscovered device will respond to the first type message.

7. The method of claim 4 wherein:
The first bit is the most significant bit;
The first binary value=the third binary value=the fifth binary value=the seventh binary value=1; and
the second binary value=the fourth binary value=the sixth binary value=the eighth binary value=0;
whereby the process of discerning the bits in the unknown address starts with the most significant bit and proceeds to test each bit by sending a test address with a new bit set to 1 and evaluating the response to determine if the unknown address is not less than the test address.

8. The method of claim 4 wherein:
The first bit is the most significant bit;
The second binary value=the third binary value=the sixth binary value=the seventh binary value=1; and
the first binary value=the fourth binary value=the fifth binary value=the eighth binary value=0;
whereby the process of discerning the bits in the unknown address starts with the most significant bit and proceeds to test each bit by sending a test address and evaluating the response to determine if the unknown address is greater than the test address.

9. A method for discovering an address of a currently undiscovered device with an N-bit address on a shared media with a downstream channel and an upstream channel, where N is greater than 2, the method comprising:
A. Sending a first type message on the downstream channel;
B. Interpreting a response occurring on the upstream channel as confirmation of the existence of at least one undiscovered device;
C. Do Until all bits of the unknown device address are known:
i. sending a downstream message having a specified address value;
ii. discerning whether a response was sent on the upstream channel to the downstream message;
iii. determining one bit of the address of the undiscovered device from whether a response was sent on the upstream channel to the downstream message; and
D. Sending an instruction to the discovered device through use of the discerned address to instruct the discovered device to not respond to subsequent first type messages.

10. The method of claim 9 wherein the step of interpreting a response occurring on the upstream channel as confirmation of the existence of at least one undiscovered device comprises using a level indicator to detect a response such that the ability to detect a response is not impacted by bus contention from multiple responses.

11. A method for first device to poll a group of client devices connected to a shared media with a downstream channel and an upstream channel, the method comprising:
A. assigning each discovered client device a specific time slot for responding to a polling broadcast message;
B. transmitting the polling broadcast message on the downstream channel;
C. discerning which discovered client devices responded in their respective assigned time slots; and
D. sending each of the responding client devices a polling message specifically addressed to that responding client device to request that the addressed device send data on the upstream channel.

12. The method of claim 11 wherein a time slot allocated for a response from a device with data to the polling broadcast message is less than half the time required on the upstream channel for transmission of an upstream frame from a polled client device with upstream data to transmit.

13. The method of claim 11 where a particular client device with data to transmit responds to the polling broadcast message with a short burst of energy in its allocated time slot.

14. The method of claim 13 wherein the particular client device with data to transmit indicates that it has data to transmit by responding with a short burst of energy in a particular portion of the allocated time slot and responds with a short burst of energy in a different portion of the allocated time slot when the particular client device does not have data to transmit.

15. The method of claim 11 wherein the step of assigning each discovered client device a specific time slot for responding to a polling broadcast message includes the sub-step of assigning the client device to a sub-group of client devices that respond to a particular polling broadcast message.

16. The method of claim 11 wherein undiscovered client devices without a specific allocated time slot respond to the transmission of the polling broadcast message in a time slot reserved for undiscovered client devices.

17. The method of claim 16 wherein the existence of a response from at least one undiscovered client devices in the time slot reserved for undiscovered client devices is detected using a level indicator to detect a response such that the ability to detect a response is not impacted by bus contention from multiple responses.

18. The method of claim 16 wherein the detection of a level change during the time slot reserved for undiscovered client devices initiates a process comprising the steps of:
A. identifying the address of an undiscovered client device;
B. providing the newly identified device with a specific time slot for responding to a polling broadcast message instead of the time slot reserved for undiscovered devices; and
C. storing information linking the time slot assigned to the newly discovered client device to the address of the newly discovered client device.

19. The method of claim 16 wherein the detection of a level change during the time slot reserved for undiscovered client devices triggers:
A. Sending a first type message on the downstream channel; and
B. Interpreting a response occurring on the upstream channel as confirmation of the existence of at least one undiscovered device.
